(19) United States
(12) Patent Application Publication
(10) Pub. No.: US 2006/0081079 A1
(43) Pub. Date: Apr. 20, 2006

(54) Linear drive with emergency adjustment possibility

(76) Inventors: Victor Jaecklin, Baden (CH); Marcel Soltermann, Cedarburg, WI (US)

Correspondence Address: MCGLEW & TUTTLE, PC, P.O. BOX 9227, SCARBOROUGH STATION, SCARBOROUGH, NY, 10510-9227, US

(21) Appl. No.: 11/229,988

(22) Filed: Sep. 19, 2005

(30) Foreign Application Priority Data
Sep. 20, 2004 (CH) CH 01543/04

(51) Int. Cl. F16H 27/02

(52) U.S. Cl. 74/89.23

(57) ABSTRACT

The possibility of manipulating errors of an emergency or quick adjusting means shall be ruled out at least extensively in a linear drive. It is proposed for this purpose, for a linear drive with a spindle (9), which can be rotatingly driven on the drive side by a motor (2), where the rotary motion of said spindle in the direction of the driven side (3) of the linear drive can be converted into an at least essentially translatory motion of a gear member, which is in functional connection with the spindle (9), and said linear drive is provided, furthermore, with a torsional connection between the gear member and a connection part. The linear drive can be connected with the connection part on a driven side (3) to a load, which is to be adjusted, the torsional connection being able to be released by an adjusting device in order to permit a motor-independent adjusting motion of the linear drive, even though structure for emergency and/or quick adjustment are present. The torsional connection is able to be released by an adjusting element of the adjusting device only for motions in always only a single, predetermined relative direction of rotation between the spindle and the gear member.

### CROSS REFERENCE TO RELATED APPLICATIONS

This application claims the benefit of priority under 35 U. S.C. §119 of Swiss Application CH 01543/04 filed Sept. 20, 2004, the entire contents of which are incorporated herein by reference.

### FIELD OF THE INVENTION

The present invention pertains to a linear drive with a spindle, which can be rotatingly driven on the drive side by a motor and whose rotary motion can be converted in the direction of the driven side of the linear drive into an at least essentially translatory motion of a gear member functionally connected to the spindle, the linear drive having, furthermore, a torsional connection between the gear member and a connection part, wherein the linear drive can be connected on a driven side to a load, which is to be adjusted and, and the torsional connection being able to be released by means of an (emergency or quick) adjusting means in order to permit a motor-independent adjusting motion of the linear drive. It is assumed in connection with the present invention that the driven side is separated (imaginarily) from the drive side of the linear drive in the direction of the flow of forces by the adjusting means.

### BACKGROUND OF THE INVENTION

A rotary driving motion of a motor is converted in such linear drives into a linear useful motion, as this is often provided, for example, in drives for beds, patient beds as well as in other medical engineering units. In most cases, the spindle of such linear drives has an external thread, in which a nut is arranged in such a way that it can perform rotary motion and, as a result, also longitudinal displacing motion relative to the spindle. The translatory relative motion of the nut in relation to the spindle is then transmitted to a push rod, which is in functional connection with the nut. At the push rod or with the push rod, such linear drives have a connection part, for example, a fork head, to which a load, which is to be moved, can be attached. The longitudinal motion of the push rod is utilized to move the load.

Especially in medical applications, motor-independent adjustment of the linear drive shall often be possible. Such an adjustment becomes important, among other things, either when a defect occurs on the drive side, for example, the motor fails, or when a controlled and drive-independent adjustment is necessary. Such a possibility of using the linear drive may also be meaningful to make possible a controlled adjustment of the linear drive at a rate of adjustment that exceeds the rate of adjustment of the push rod that can be reached with the motor. Thus, the adjusting means can also be used as a so-called emergency lowering means, with which, for example, a head part of a bed can be moved into a horizontal position in a controlled manner and fast enough in case of an emergency. Since the linear drive is usually loaded with the load during the adjustment and it frequently happens that self-locking threads are not used on the spindle, a brake may be necessary, as this is shown in Swiss Patent Specification No. CH 0423/03. A quick adjustment, by which, for example, a patient shall be transferred into an end position of a bed or operating table—and consequently also into an end position of the drive—may also be an application of a motor-independent adjustment possibility. This adjustment possibility, which is also significant for the present invention, is usually called quick adjustment.

To make possible an emergency adjustment or also a quick adjustment, so-called loop springs (also called looping springs) have already been used in connection with the linear drives mentioned in the introduction. A loop spring is usually arranged for this purpose in a sleeve-like brake bushing, the loop spring having pin-shaped ends on both sides, which point approximately radially inwardly. These ends are used to come into contact with drive-side or driven-side carriers, as a result of which the radius of the loop spring is either slightly increased or widened. As a result, an outer surface of the turns of the loop spring comes in turn into contact with an inner surface of the brake bushing or is lifted off from the latter. Depending on whether there is a contact between the loop spring and the brake bushing, a brake torque is generated or such a torque is prevented from building up.

For emergency or quick adjustment, provisions are usually made to at least extensively release the connection between the loop spring and the brake bushing. However, the prior-art solutions have the drawback that operating errors or even safety problems may also occur in case of such emergency or quick adjustments. For example, a push rod of the linear drive, which is torsionally connected to the threaded nut in such a way that they, can be moved almost completely out of the jacket tube by actuating the adjusting means. Even though provisions are made, as a rule, for the push rod to actuate in this case a limit switch, which switches off the linear drive completely for safety reasons, it is nevertheless usually necessary now to have a technician restore the ability of the linear drive to operate, which means a downtime of the linear drive and causes costs.

### SUMMARY OF THE INVENTION

The basic object of the present invention is therefore to provide a linear drive of the type mentioned in the introduction, in which the possibilities of such manipulating errors are ruled out at least extensively, even though means for emergency and/or quick adjustment are present.

This object is accomplished according to the present invention in a linear drive of the type mentioned in the introduction by the torsional connection between the spindle and the gear member being able to be released by means of an adjusting element of the adjusting means only for motions taking place always in a single, predetermined relative direction of rotation.

The present invention is based on the idea of providing design measures by which a limitation of a possibility of release is achieved for carrying out motions during actuation of the (emergency) adjusting means. These measures may preferably be taken in the adjusting device itself For example, by limiting the possibilities of actuation, the adjusting means can either be actuated for this purpose in one direction only or, in case of actuation in, e.g., two directions, only one direction of actuation can also lead to uncoupling of the driven side from the drive or the motor. The gear member, which can be moved in a translatory motion during normal operation, for example, a threaded nut or a push rod, can be released for a rotary motion in this case. It may now be preferred that a torsional connection be generated between the drive-side gear member that can be moved in a translatory manner and the connection part when the adjusting element is actuated to move it into a non-release actuated position or, if such a connection is already present, that this connection be maintained.

In a solution that is especially favorable in terms of design, a loop spring, which is known per se and which is also called coil spring or brake spring, may be provided. Such a machine element is especially suitable in connection with the present invention because such a coil spring is already frequently used in such linear drives anyway, especially in connection with emergency adjusting means for linear drives. Even though such machine elements are sufficiently known in connection with linear drives of this type, the function according to the present invention has not yet been embodied so far. The preferred embodiment of a linear drive with a coil spring makes it possible to expand existing constructions with the function according to the present invention with an especially low effort.

Provisions may be made in a preferred variant according to the present invention for always acting on only one of the two ends of the coil spring by actuating the adjusting element in a certain direction of actuation, wherein this action leads to an at least local reduction of a diameter of the coil spring. The reduction of the diameter may lead to the release of a connection between the coil spring and a brake bushing belonging to it, which connection is, for example, a frictionally engaged connection and exists during the normal operation of the linear drive.

In case of actuating the adjusting element in another direction of actuation, the diameter of the coil spring should, by contrast, be expanded, as a result of which a torsional connection is generated or maintained between the coil spring and the brake bushing. The emergency adjustment is not released hereby.

A rotary adjusting motion can be preferably carried out as the adjusting motion with the adjusting element. This adjusting motion can be advantageously utilized directly as an actuating motion of the coil spring.

A first actuating body and preferably also a second actuating body may be present in embodiments that are favorable in terms of design. Both actuating bodies may have actuating elements, at least some of which can be brought into a rotary functional connection with at least one of the ends of the coil spring. One of the two actuating bodies can be functionally connected here to the adjusting element, and the other actuating body can be torsionally connected, with the driven-side connection part. Provisions may be made in a favorable embodiment for actuating elements to be arranged at spaced locations from one another on a circumference of each actuating body.

In preferred embodiments, an actuating body may have at least one less actuating element, for example, a claw, than the other actuating body. To achieve the function according to the present invention, it may now be advantageous if one end of the coil spring protrudes into an area between two actuating elements of one of the two actuating bodies and no actuating element of the other actuating body is present in his area.

Other preferred embodiments of the present invention appear from the claims, the description and the drawings. The present invention will be explained in greater detail on the basis of exemplary embodiments shown schematically in the figures. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a partially cut-away perspective view of a linear drive according to the present invention;

FIG. 2 is a perspective view of a load-side end of the linear drive;

FIG. 3 is a partially cut-away perspective view of the adjusting means from FIG. 2;

FIG. 4 is longitudinal sections of the adjusting means from FIG. 2 and FIG. 3;

FIG. 5 is a perspective view of a coupling element of the adjusting means;

FIG. 6 is a perspective view of a coil or loop spring of the adjusting means;

FIG. 7 is a view showing an actuation of the adjusting means in a direction of actuation in which emergency adjustment becomes possible;

FIG. 8 is a view showing an actuation of the adjusting means in another direction of actuation in which emergency adjustment is not possible; and

FIG. 9 is a perspective view of a rotating ring of the adjusting means.

### DESCRIPTION OF THE PREFERRED EMBODIMENTS

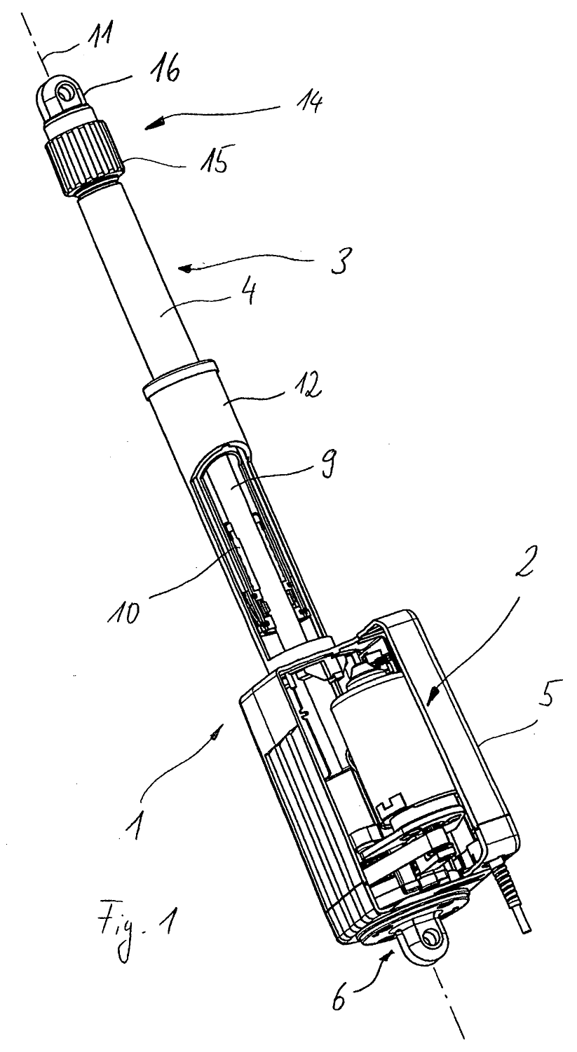

Referring to the drawings in particular, the linear drive shown in FIG. 1 has on a drive side 1 an electric motor 2, by the rotary drive motion of which a longitudinal motion of a push rod 4 provided on a drive side 1 is brought about. A drive-side fork head 6, with which the linear drive can be fastened in a plant, a medical inventory item, a piece of furniture, a machine or the like, is provided at a housing 5 of the motor 2. The principal applications of this linear drive are patient beds, operating tables, lifters, especially patient lifters, and other like medical and related applications.

A rotary motion of a motor shaft is transmitted to a spindle 9, which may have a non-self-locking or a self-locking external thread. To transform the rotary motion of the motor into a slow motion, a gear mechanism, especially a toothed gearing, for example, a planet gear, may be inserted between the motor 2 and the spindle 9.

A threaded nut 10 is located on the spindle 9. The threaded nut 10 is connected to a push rod 4 and is arranged to move in relation to the spindle 9. The push rod 4 can be withdrawn into and extended from a jacket tube 12 as a result along a longitudinal motion axis 11. The threaded nut 10 or the push rod 4 according to this exemplary embodiment can be defined as a gear member in the sense of the present invention. Both the spindle 9, the threaded nut 10, the jacket tube 12, on the one hand, and the push rod 4, on the other hand, are arranged concentrically with the longitudinal motion axis 11, which is also the axis of rotation of the spindle 4 at the same time. The longitudinal motion of the push rod 4 takes place because of a rotary motion of the spindle 9, which is converted in a known manner into a translatory motion of the threaded nut 10.

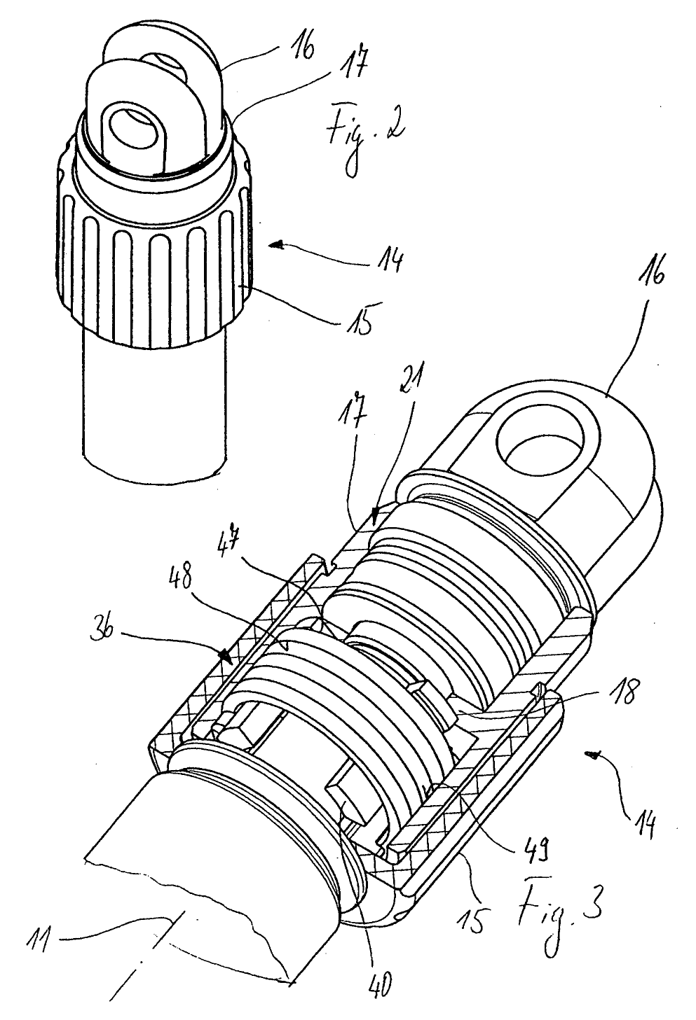

An emergency adjusting means 14, which is shown in greater detail in FIGS. 2 through 9 and which has a rotating ring 15, which is accessible from the outside, is located at the upper end of the push rod 4. The rotating ring is also arranged concentrically in relation to the longitudinal motion axis 11. The rotating ring 15 is joined by a load-side fork head 16, to which a load, which is to be moved by the linear drive (during its normal operation) and is not shown in greater detail, can be attached.

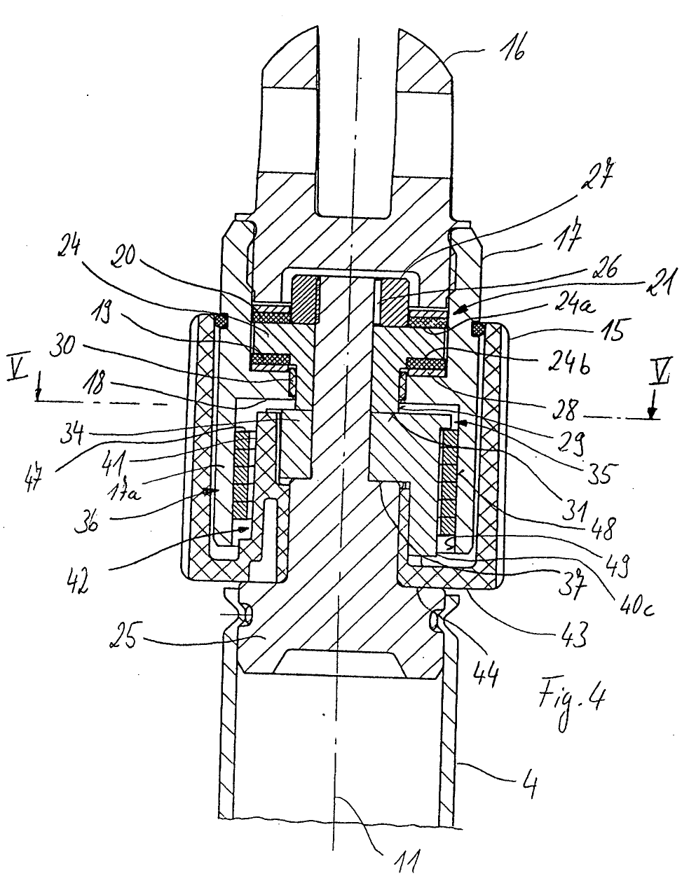

The fork head 16 is torsionally mounted to the upper end of a mounting sleeve 17. Ring-shaped first and second brake disks 19, 20 (FIG. 4) of a first brake means 21 are provided on an upper side of a radial inner shoulder of the mounting sleeve 17. The brake disks 19, 20 have brake surfaces and are in contact with different faces 24a, 24b of a ring 24. The brake means and its mode of action are described in greater detail in the patent application CH 0423/03 of the same applicant. The contents of this older patent application are therefore fully incorporated herewith by reference.

The ring 24 is pushed over an upper end of a mounting body 25. A lock nut 27 screwed onto a thread 26 of the mounting body 25 presses the ring 24 in the direction of the push rod 4. A slide bearing 30, which is used to radially center the ring 24, is provided between the radial shoulder 18 and a jacket surface 29 of the ring 24.

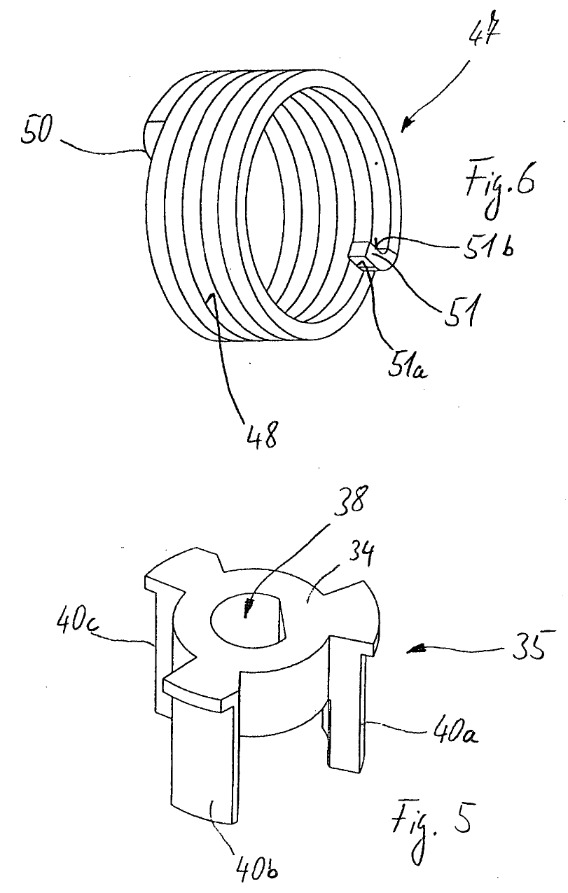

With an end-side face 31 of the ring 24, which face faces away from the fork head 16, the ring 24 is in contact with an outer face of a ring-shaped bottom part 34 of a first claw body 35. This claw body, shown specifically in FIG. 5, is part of a loop ring brake, which is located under a radial shoulder 18 (FIG. 4) of the mounting sleeve 17. The part of the mounting sleeve 17 that is located under the shoulder 17 is called the brake bushing 17a. The loop spring brake acts as a second brake means of the linear drive. For its mode of action and its cooperation with the first brake means, reference is made to the older Swiss Patent Application CH 0423/03 mentioned above, whose disclosure content is included by reference.

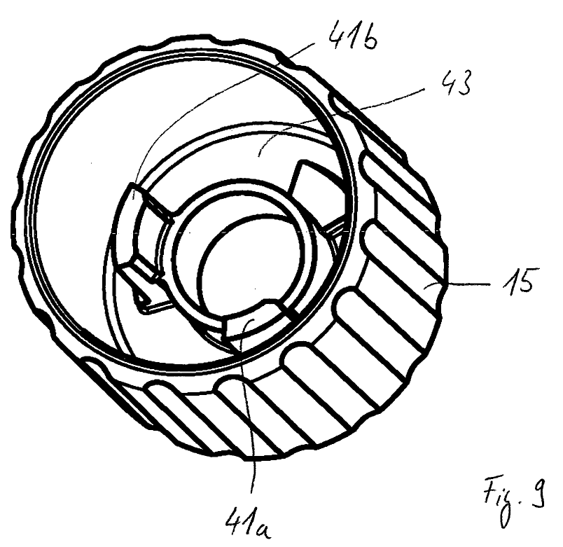

With its inner side, the bottom part 34 is in contact with a first shoulder 37 of the mounting body 25. The lock nut 27 now presses the first claw body 35 against the shoulder 37 via the ring 24. In the area of the longitudinal motion axis 11, the bottom part 34 has a clearance 38, through which is led the mounting body 25 (FIG. 4 and FIG. 5). With a flattened area 39 of an otherwise round cross-sectional shape, the mounting body 25 is in contact with a corresponding flattened area of the clearance 38, as this is apparent, among other things, from the cross-sectional view in FIG. 8. As a result, the first claw body 35 is torsionally secured on the mounting body 25.

Three elongated claws 40a, 40b and 40c, which are arranged at spaced locations from one another and are directed essentially in parallel to the longitudinal motion axis 11, are arranged as carriers on the circumference of the bottom part 34 of the first claw body 35 in a uniformly distributed manner. However, another number of claws 40a-c could also be present instead of three claws 4a-c.

A second claw body 42 has only two claws 41a, 41b, which are arranged at spaced locations from one another. The free ends of the two claws 41a, 41b are located directly opposite the bottom part 34 of the first claw body 35. The claws 41a, 41b of the second claw body 42 also extend essentially in parallel to the longitudinal motion axis 11. The claws 11 are connected via a front-side ring section 43 in one piece to the rotating ring 15 (cf. FIG. 9), whose longitudinal extension is likewise directed essentially in parallel to the claws 40, 41. The claws 40a-c, 41a-c are thus located within the rotating ring 15. The rotating ring 15 is in contact by its ring section 43 with another shoulder 44 of the mounting body 25, as a result of which the adjusting means is clamped between the lock nut 27 and the shoulder 44.

The claws 40a-c, 41a-b of both claw bodies 35, 42 are surrounded by a coil spring 47. The coil spring 47, shown as an individual part in FIG. 6, is wound with a small pitch, as a result of which the individual turns are approximately in contact with one another and are located at least very close to one another. The length of the coil spring 47 in the direction of the longitudinal motion axis 11 approximately corresponds to the length of the claws 40a-c, 41a-b.

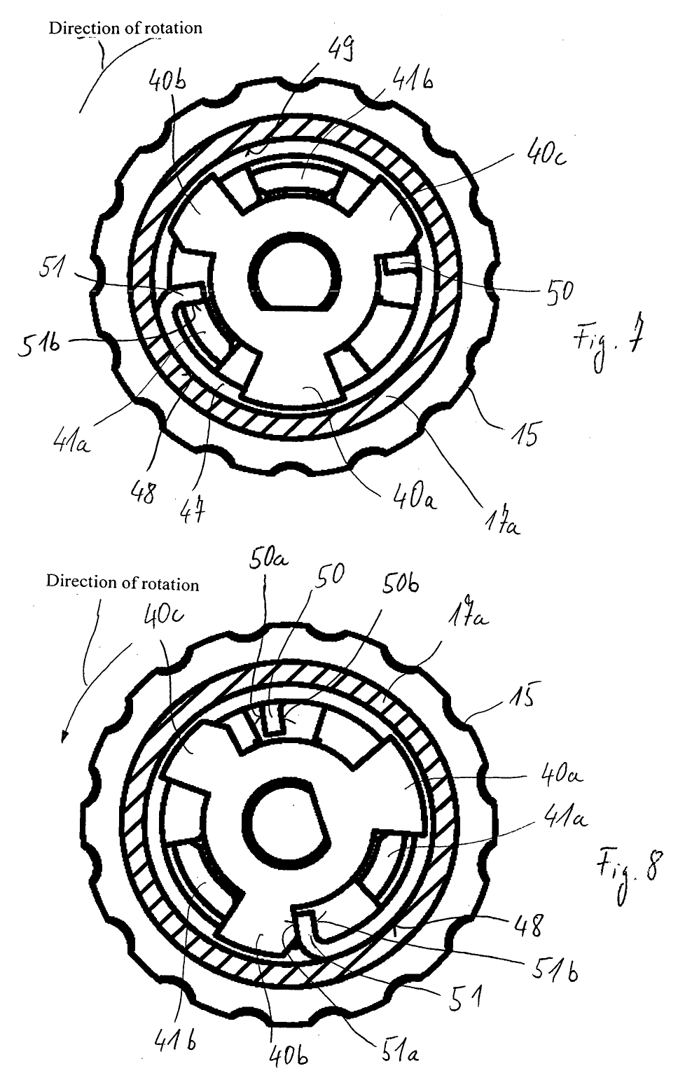

The two ends 50, 51 of the coil spring are bent approximately radially inwardly in relation to the longitudinal motion axis 11 and offset in relation to one another in relation to the circumferential direction. As can be recognized especially from FIGS. 7 and 8, each of the two claws 41a, 41b of the claw body 42 is arranged between two claws 40 each of the claw body 35. Thus, a claw 41a, 41b of the second claw body 42 each follows one of the claws 40a-c of the first claw body 35 in the circumferential direction. There is no claw of the second claw body 42 between the two claws 40a, 40c of the first claw body 35 only. The end 51 of the coil spring 47, which is the front end in FIGS. 7 and 8, protrudes into the space between the claw 40b of the first claw body 35 and second claw 41a of the second claw body 42. The other, drive-side end 50 is located, by contrast, between the two claws 40a, 40c of the first claw body 35, between which no claw of the second claw body 42 is arranged. The claws 40a-c, 41a-b have the function of carriers and can be brought into contact with lateral surfaces of the claws 40a-c, 41a-b, as will be explained in greater detail below, by a rotary motion of the claw bodies 35, 42.

An outer surface 48 of the coil or looping spring 47, which surface acts as a brake surface, is in contact with an inner surface 49 of the brake bushing 17a during normal operation, as this can be recognized in connection with FIGS. 3, 4, 6, 7 and 8. Normal operation is defined as a state in which a drive motion of the motor 6 can be transmitted as a translatory motion to the fork head 16.

During a beginning rotary motion of the spindle 9 because of a drive motion of the motor 6, it is possible that the coil spring 47 is at first not torsionally connected to the brake bushing 17a. However, since the first claw body 35 is connected to the push rod 4 in such a way that they are torsionally connected and thus rotate together, a claw 40b, 40c of the first claw body 35 comes into contact with an outer side 50a, 51a of one of the ends 50, 51 of the coil spring. As a result, the diameter of the coil spring is expanded already after a very small angle of rotation. The coil spring thus gradually comes into contact, over its entire outer surface 48, with the inner surface 49 of the brake bushing 17a. A torsional connection is generated between the push rod 4 and the mounting sleeve 17—and consequently also the fork head 16—by the frictional engagement. This is true regardless of the direction of rotation of the spindle 9. Since the fork head 16 is in turn connected to the load to be moved in such a way that they are torsionally connected, the rotary motion of the spindle is converted into an exclusively translatory feed motion of the fork head 16.

If, by contrast, the push rod 4 is withdrawn into the jacket tube 12 in the direction of the load by means of the (emergency) adjusting means 14, the rotating ring 15 must be rotated for this purpose relative to the jacket tube 12 in a defined direction of rotation. It is a clockwise rotation in the view shown in FIG. 7. As a result, the claw 41a of the second claw body 42 comes into contact with the front end 51 of the coil spring 47. The claw 41 a now presses an inner side 51b of the coil spring 47, as a result of which the latter will contract. The reduction of the diameter of the coil spring 47, which is associated with this, releases the frictional engagement between the coil spring 47 and the mounting sleeve 17 at least partially.

If a load, for example, a weight, now presses the fork head 16, this load is introduced via the fork head 16 into the friction disk 22 and the second brake disk 20. The flux of force extends from there via the ring 24 into the bottom part 34 of the claw body 35 and then into the mounting body 25. The latter transmits the pressing force of the load via the push rod 4 into the spindle 9. Since the thread of the spindle 9 is preferably not self-locking, the nut 10 begins to move down on the thread of the spindle 9. The friction between the brake disk 20 and a friction disk 22 located opposite it absorbs part of the energy originating from the load. Only the remaining portion of the energy will still act as a torque and consequently as an energy of rotation on the threaded nut 10. The torque that can be transmitted between the push rod 4 and the fork head 16 is lower than the torque generated by the axial force in the spindle and the threaded nut. Since the spindle 9 is locked by the motor, the nut 10 thus begins to move down on the spindle 9, as a result of which the push rod moves into the jacket tube.

The rotary motion of the threaded nut 10 begins immediately after the diameter of the coil spring 47 has been reduced with a rotary motion of the rotating ring 15 in the clockwise direction (according to the view in FIG. 7) and the frictional engagement between the mounting sleeve and the coil spring has been eliminated hereby to a sufficient extent. If the rotary motion of the rotating ring 15 is continued beyond this, the coil spring 47 and finally also the first claw body 35 are carried by the second claw body 42 during the rotary motion of the latter. The push rod 4 follows this motion together with the first claw body 35, which is torsionally connected to the push rod via the mounting body and together with the coil spring 47. The push rod 4 will then rotate by the angle of rotation by which the rotating ring 15 is rotated by hand. If the rotary motion of the rotating ring 15 is stopped, the rotary motion of the coil spring 47 is stopped as well. The rotary motion of the rotating ring 15 in the clockwise direction, with which the release of the push rod 4 was initiated for a rotary motion, thus corresponds to the direction of rotation of the push rod 4 during the withdrawing motion of the latter into the jacket tube 12.

However, the first claw body 35, which is torsionally connected to the fork head 16 (and the load), still continues to rotate somewhat. Due to the relative motion now taking place between the first claw body 35 and the coil spring 47, one of the claws 40 will be pressed from the outside against one of the ends 50, 51 of the coil spring 37. As a result, the diameter of the coil spring 47 is again increased, as a result of which frictional engagement is again generated between the coil spring 47 and the mounting sleeve 17. The fork head 16 is thus again torsionally connected to the push rod 4, as a result of which the rotary motion is stopped by the load, which still continues to act on the push rod 4.

The push rod 4 has now traveled in the direction of the longitudinal motion axis 11 over a path that corresponds to the completed angle of rotation of the rotating ring 15. To travel over longer paths with the push rod 4, the rotating ring 15 can be actuated several times. Thus, a defined path of the push rod 4 is assigned to each angle of rotation of the rotating ring 15. Provisions may also be made in other embodiments of the present invention for the (emergency) adjusting means to be only released by means of the rotating ring 15 or another adjusting element without there being any relationship between the angle of rotation and the length of the displacement of the push rod along the longitudinal motion axis 11. The adjusting means is a so-called quick adjusting means in this case.

If the rotating ring is now rotated counterclockwise (relative to FIGS. 7 and 8) rather than clockwise as before, the claws 41a and 41b of the second claw body 42 will come into contact with the first claw body 35. In particular, the claw 40b of the first claw body 35 is carried as a result by the claw 41b, as a result of which the claw 40b is pressed against an outer side 5la of the end 51 of the coil spring 47, which end is the front (driven-side) end in FIG. 8. As a result, the diameter of the coil spring 47 (brake spring) will tend to increase. If not present already, a torsional connection will develop as a result between the push rod and the brake bushing 17a. It is ensured by this connection that the drive with the emergency lowering can be actuated in the intended load direction only. The positions of the ends 50, 51 of the coil spring 47 and of the claws 40a-c, 41a-b contribute to one of the claws coming into contact with an inner surface of one of the two ends 50, 51 during a counterclockwise direction of rotation and to the frictional connection not being able to be released between the coil spring and the brake bushing 17a.

Even though the rotating ring 15 can be actuated in two directions in this exemplary embodiment, the emergency lowering itself is effective, however, in a described, predetermined direction of rotation only, in which the rotating ring 15 and consequently also the threaded nut 10 have a clockwise direction of rotation (relative to FIGS. 7 and 8). As a result, a load can be transmitted from the driven side to the drive side and can be converted into a torque in only one predetermined direction of rotation of the threaded nut, and consequently also of the push rod 4 in relation to the spindle. If the rotating ring is actuated counterclockwise in the view shown in FIG. 8, a torsional connection is either generated or strengthened from the push rod 4 toward the fork head 16, as a result of which the push rod can be extended from the jacket tube by a motor-driven linear displacement only.

While specific embodiments of the invention have been shown and described in detail to illustrate the application of the principles of the invention, it will be understood that the invention may be embodied otherwise without departing from such principles.

What is claimed is:

1. A linear drive, comprising:
a motor;
a gear member;
a spindle rotatingly driven on a drive side by said motor, rotary motion of said spindle being converted in the direction of the driven side of said linear drive into an at least essentially translatory motion of said gear member, said gear member being in functional connection with said spindle;
a connection part and a torsional connection between said gear member and said connection part, wherein said torsional connection may be made with said connection part on said drive side to a load, which is to be adjusted;
an adjusting means, said torsional connection able to be released by means of said adjusting means in order to permit a motor-independent adjusting motion of the linear drive, said adjusting means including an adjusting element wherein the torsional connection can be released by means of said adjusting element of the adjusting means only for motions always in only one predetermined relative direction of rotation between said spindle and said gear member.

2. A linear drive in accordance with claim 1, wherein a connection between said gear member and the connection part, which was previously said torsional connection, can be released at least partially by an actuation of the adjusting element of the adjusting means in a first direction of adjustment and the torsional connection is generated during actuation in another direction of adjustment or an already existing said torsional connection is secured.

3. A linear drive in accordance with claim 1, wherein the adjusting means has a coil spring, which cooperates with a brake bushing, and is arranged in said brake bushing, and with which a frictional connection with said brake bushing can be generated and at least partially released.

4. A linear drive in accordance with claim 3, wherein said adjusting element acts on at least one of said ends of said coil spring, this action leading to an at least local increase or decrease of a diameter of said coil spring.

5. A linear drive in accordance with claim 3, wherein only one of ends of said coil spring can be acted on with said adjusting element.

6. A linear drive in accordance with at least claim 2, wherein an actuation of said adjusting element of said adjusting means in said first direction of adjustment leads to an at least local increase said actuation in another direction of adjustment leads to an at least local decrease of the diameter of said coil spring.

7. A linear drive in accordance with claim 3, wherein at least an actuating body of said adjusting means is provided, which said actuating body can be brought into functional connection with said coil spring, and at which a plurality of actuating elements arranged at spaced locations from one another are formed.

8. A linear drive in accordance with claim 7, wherein rotation of said actuating elements can be brought about with said adjusting element, and at least one of said adjusting elements will as a result come to lie directly or indirectly against one end of said coil spring.

9. A linear drive in accordance with claim 7, wherein a second actuating body is provided, which is provided with a plurality of actuating elements located at spaced locations from one another and which cooperates with said first actuating body.

10. A linear drive in accordance with claim 9, wherein one of said two actuating bodies has a smaller number of said actuating elements than said other actuating body.

11. A linear drive in accordance with claim 10, wherein said actuating elements are not distributed uniformly around an axis of rotation of said actuating body at one of said two actuating bodies.

12. A linear drive in accordance with claim 9, wherein said two actuating bodies are pushed one into another and can be rotated in relation to one another and one said actuating element of one said actuating body comes into contact with an actuating element of said other actuating body after a rotary motion and one said actuating body carries said other actuating body in its rotary motion.

13. A linear drive in accordance with claim 9, wherein one of said ends of said coil spring protrudes into an area between two said actuating elements of said same actuating body, and no said actuating element of said other actuating body is located between these two said actuating elements.

14. A linear drive in accordance with claim 9, wherein during the motion of said adjusting element in one defined direction of adjustment only, only one said defined actuating element of one of said two actuating bodies will always act on said coil spring such that a torsional connection between said coil spring and said brake bushing can be released as a result at least partially.

15. A linear drive in accordance with claim 7, wherein at least one of said actuating bodies is designed as a claw body, at which a plurality of said claws are formed as said actuating elements.
